(19) United States
(12) Patent Application Publication
(10) Pub. No.: US 2013/0159219 A1
(43) Pub. Date: Jun. 20, 2013

(54) Predicting the Likelihood of Digital Communication Responses

(71) Applicants: Patrick Pantel, Bellevue, WA (US); Michael Gamon, Seattle, WA (US); Yoav Y. Artzi, Seattle, WA (US)

(72) Inventors: Patrick Pantel, Bellevue, WA (US); Michael Gamon, Seattle, WA (US); Yoav Y. Artzi, Seattle, WA (US)

(73) Assignee: MICROSOFT CORPORATION, Redmond, WA (US)

(21) Appl. No.: 13/325,386

(22) Filed: Dec. 14, 2011

(51) Int. Cl. G06F 15/18; G06N 5/00

(52) U.S. Cl. 706/12; 706/45

(57) ABSTRACT

Different advantageous embodiments provide for response prediction. A social element is received by a prediction mechanism. A feature set is generated for the social element. A prediction is generated using the feature set and a prediction model.

### BACKGROUND

Social networking services provide a platform for the dissemination of information among people who share like interests. Each user of a social networking service has a representation, or profile, that allows the user to interact with other users over the Internet. Social networking has become a means for connecting and communicating digitally in real-time.

Amongst the leading social networking services is a platform for sharing information in segments, or microblogs, often with a limitation on the number of characters used in a particular segment. Other services provide a platform for sharing digital information that includes images in addition to text and numeric characters. With millions of users worldwide posting billions of segments of information per day, social networking services represent a vast information fountain. However, only a small portion of the information posted via these social networking services on a daily basis receive engagement from the wider community.

Accordingly, it would be advantageous to have an apparatus and method for providing users of social networking services with a means for receiving engagement from the community in response to the information shared.

### SUMMARY

This Summary is provided to introduce a selection of representative concepts in a simplified form that are further described below in the Detailed Description. This Summary is not intended to identify key features or essential features of the claimed subject matter, nor is it intended to be used in any way that would limit the scope of the claimed subject matter.

Briefly, various aspects of the subject matter described herein are directed towards predicting the likelihood of a response. A social element is received by a prediction mechanism. A feature set is generated for the social element. A prediction is generated using the feature set and a prediction model

Another aspect is directed towards response prediction. A prediction mechanism is configured to analyze a social element and generate a prediction associated with the social element using a prediction model.

Yet another aspect is directed towards training a response predictor. A feature value extractor is configured to extract one or more feature values form one or more social elements. A feature vector generator is configured to generate one or more feature vectors for the one or more social elements using the one or more feature values extracted by the feature value extractor. A prediction model is configured to generate a prediction using the one or more feature vectors generated.

Other advantages may become apparent from the following detailed description when taken in conjunction with the drawings.

### BRIEF DESCRIPTION OF THE DRAWINGS

The present invention is illustrated by way of example and not limited in the accompanying figures, in which like reference numerals indicate similar elements. The advantageous embodiments, as well as a preferred mode of use, further objectives and advantages thereof, will best be understood by reference to the following detailed description of an advantageous embodiment of the present disclosure when read in conjunction with the accompanying drawings, wherein:

FIG. 1 is an illustrative example of a social environment in which an advantageous example embodiment may be implemented;

FIG. 2 is an illustrative example of a social environment in which an advantageous example embodiment may be implemented;

FIG. 3 is a block diagram illustrating an example of a feature value extractor in accordance with an advantageous example embodiment;

FIG. 4 is a flow diagram representative of example steps in training a response predictor in accordance with an advantageous example embodiment;

FIG. 5 is a flow diagram representative of example steps in predicting a response in accordance with an advantageous example embodiment; and

FIG. 6 is a block diagram representing an example computing environment into which aspects of the subject matter described herein may be incorporated.

### DETAILED DESCRIPTION

Various aspects of the technology described herein are generally directed towards predicting whether or not a social element will receive a response from the social community. As will be understood, a social element may be a digital communication, such as a microblog or other content communication, such as a Tweet® for example, that is posted to a social networking service, such as Twitter® for example.

While the various aspects described herein are exemplified with a social environment directed towards predicting whether or not a social element will receive a response from the social community, it will be readily appreciated that other environments and communities may benefit from the technology described herein. For example, the various aspects described herein may be used to predict whether or not a medical question will receive a response from an online medical community in a medical environment.

Thus, as will be understood, the technology described herein is not limited to any type of environment or community for the dissemination and investigation of information. As such, the present invention is not limited to any particular embodiments, aspects, concepts, protocols, structures, functionalities or examples described herein. Rather, any of the embodiments, aspects, concepts, protocols, structures, functionalities or examples described herein are non-limiting, and the present invention may be used in various ways that provide benefits and advantages in prediction of responses to digital information.

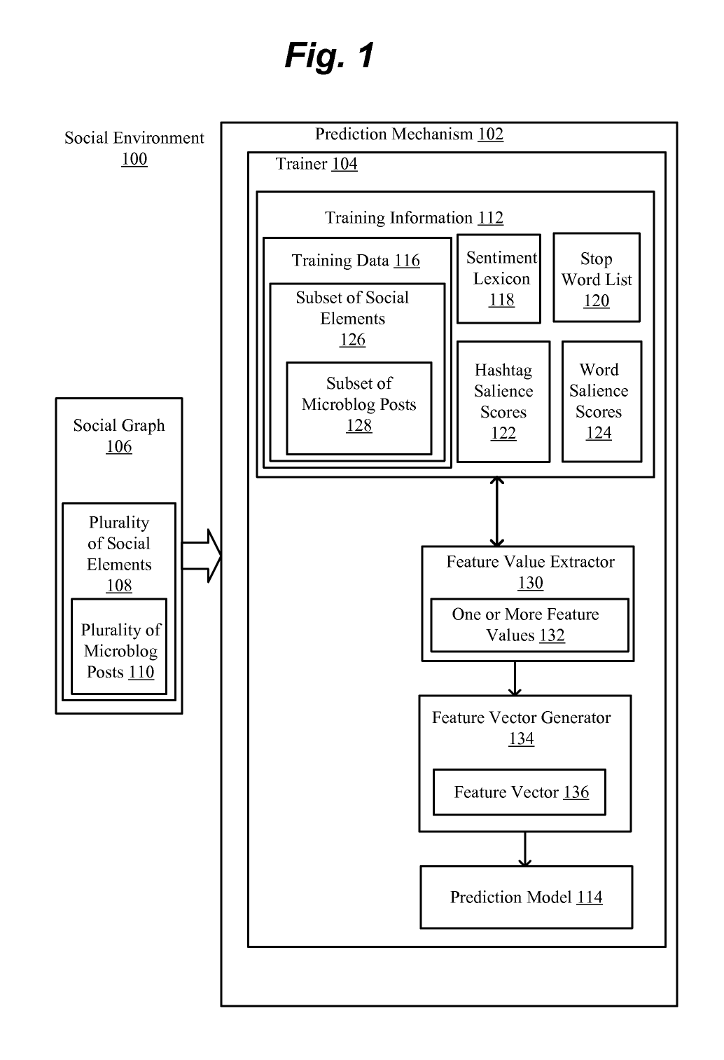

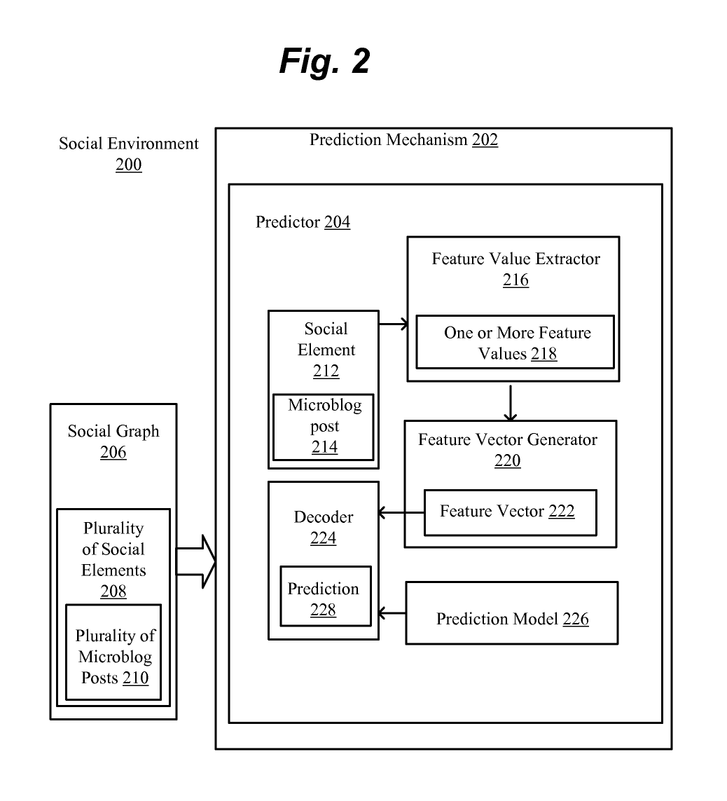

With reference now to the figures and in particular with reference to FIGS. 1-2, diagrams of data processing environments are provided in which advantageous embodiments of the present invention may be implemented. It should be appreciated that FIGS. 1-2 are only illustrative and are not intended to assert or imply any limitation with regard to environments in which different embodiments may be implemented. Many modifications to the depicted environments may be made.

FIG. 1 is an illustration of an example social environment in which advantageous embodiments of the present invention may be implemented. A social environment 100 may comprise, without limitation, a social networking environment, for example. As described herein, the social environment 100 contains a prediction mechanism 102. The prediction mechanism 102 may be implemented using a data processing system in this illustrative example.

The prediction mechanism 102 may have a number of modes, including a training mode and a prediction mode. The training mode is an offline mode. The prediction mode may be an online or offline mode. For illustrative purposes, the prediction mechanism 102 is depicted in the offline training mode. In the training mode, the prediction mechanism 102 trains a predictor to be used in a prediction mode for predicting the likelihood of a response to an information post, such as, without limitation, a Tweet® or status update, for example.

In this illustrative embodiment, the prediction mechanism 102 includes a trainer 104. In the social environment 100, the prediction mechanism 102 interacts with a social graph 106. The social graph 106 is based on a platform, or online service, that includes a representation of each user of that platform, the social links for each user, and a variety of additional services and information. The social graph 106 may be based on, for example, without limitation, a social networking service such as Twitter®.

The social graph 106 includes a plurality of social elements 108. The plurality of social elements 108 may include, for example, without limitation, user representations or profiles, user broadcasted information or posts, and/or any other suitable information provided by the social graph 106. In one illustrative embodiment, the plurality of social elements 108 includes a plurality of microblog posts 110.

In the training mode, the trainer 104 uses training information 112 to train the prediction model 114. The training information 112 includes, without limitation, training data 116, a sentiment lexicon 118, a stop word list 120, hashtag salience scores 122, and word salience scores 124.

Training data 116 consists of a subset of social elements 126. In the training mode, the trainer 104 inputs the subset of social elements 126 from the plurality of social elements 108 provided by the social graph 106 into the training information 112. The subset of social elements 126 may be mined from one or more logs, and/or collected over a suitable period of time, from the plurality of social elements 108 provided by the social graph 106, for example. The subset of social elements 126 may comprise, without limitation, a collection of microblog posts, a collection of status updates, user profiles, time and date associated with each posting, information associated with whether or not each particular post and/or update received a response, and/or any other suitable information provided by the social graph 106, for example. In one illustrative embodiment, the subset of social elements 126 includes a subset of microblog posts 128.

In one example implementation, the sentiment lexicon 118 comprises a collection of positive words and negative words. The stop word list 120 comprises a collection of words such as pronouns and articles. The hashtag salience scores 122 comprises a collection of hashtags, each with a corresponding feature value that indicates the importance of each hashtag with regard to eliciting a response. In one illustrative example, a feature value associated with a particular hashtag may be a binary value indicating either a yes or no as to the importance of that particular hashtag. In another illustrative example, a feature value associated with a particular hashtag may be granular, or scaled, such as a value between one and ten for example, indicating the degree of importance for that particular hashtag. The hashtag salience scores 122 may be generated using a sample of social elements, such as Tweets®, including social elements that did and did not receive a response. In one illustrative embodiment, for each hashtag in the sample of social elements, the ratio of the social elements containing that hashtag that did receive a response and the social elements containing that hashtag that did not receive a response is found, rounded to the nearest integer to get a number, and that number is then defined as a feature of that hashtag.

The word salience scores 124 comprises a collection of words and/or bigrams, each with a corresponding feature that indicates whether each words and/or bigram is of importance with regard to eliciting a response. The word salience scores 124 may be generated in a manner similar to that of the hashtag salience scores 122.

The training information 112 may be used in the offline mode to train the prediction model 114 that a predictor will use in a prediction mode to predict the likelihood of a response to a social element. The training information 112 is input into a feature value extractor 130. Feature value extractor 130 uses one or more feature extraction algorithms to extract one or more feature values 132 for the subset of microblog posts 128 using one or more of the subset of social elements 126, the sentiment lexicon 118, the stop word list 120, the hashtag salience scores 122, and the word salience scores 124. Each social element input into the feature value extractor 130 has a corresponding number of feature values that are then input into a feature vector generator 134. The feature vector generator 134 uses the one or more feature values 132 extracted by the feature value extractor 130 to generate a feature vector 136 for each social element input into the feature value extractor 130. In an illustrative embodiment, each microblog post will have a corresponding feature vector generated by the feature vector generator 134, for example. A feature vector may be comprised of one or more features corresponding to the microblog post, for example. The feature vectors for the training data, along with the information about whether or not each post from the subset of microblog posts 128 received a response, are used to train the prediction model 114. The prediction model 114 is a response prediction model, or a trained classifier, that is configured to enable a predictor to predict the likelihood of a new social element eliciting a response. Trainer 104 uses the feature vectors generated for the training data along with one or more training algorithms and other information associated with the subset of social elements 126 to train the prediction model 114. The training algorithms may include, without limitation, a Boosted Decision Tree classifier, a Maximum Entropy classifier, a weighted perceptron classifier, a Support Vector Machine classifier, and/or any other suitable algorithm for classification. Once the prediction model 114 has been trained, the prediction model 114 is capable of operating in a prediction mode to predict the likelihood of responses for any social element, such as a microblog post, for example.

FIG. 1 is intended as an example, and not as an architectural limitation for different embodiments. For example, in other advantageous embodiments, the prediction mechanism 102 may train a response predictor for content other than social content, such as medical questions, legal inquiries, and/or any other type of content that is generated in order to elicit a response.

With reference now to FIG. 2, an illustration of an example social environment is depicted in which advantageous embodiments of the present invention may be implemented. A social environment 200 may comprise, without limitation, a social networking environment, for example. As described herein, the social environment 200 contains a prediction mechanism 202. In one illustrative embodiment, the prediction mechanism 202 may be an implementation of prediction mechanism 102 used in a prediction mode, for example.

In the prediction mode, the prediction mechanism 202 predicts the likelihood of a response to an information post, such as, without limitation, a Tweet® or status update, for example. The prediction mechanism 202 includes a predictor 204. The prediction mechanism 202 may interact with a social graph 206. The social graph 206 may be an implementation of the social graph 106 in FIG. 1, for example. The social graph 206 includes a plurality of social elements 208. In an illustrative embodiment, the plurality of social elements 208 may include a plurality of microblog posts 210.In the online mode, the predictor 204 receives a social element 212 from the plurality of social elements 208 provided by the social graph 206. The social element 212 may be, for example, without limitation, a microblog post 214. In an illustrative embodiment, when the predictor 204 receives the microblog post 214, the predictor 204 passes the microblog post 214 into a feature value extractor 216 to generate one or more feature values 218 for the microblog post 214. The feature value extractor 216 may be an illustrative implementation of the feature value extractor 130 in FIG. 1, used in the prediction mode of the social environment 200.

The one or more feature values 218 for the microblog post 214 are input into the feature vector generator 220. The feature vector generator 220 may be an illustrative implementation of the feature vector generator 134 in FIG. 1, used in the online mode of the social environment 200. The feature vector generator 220 generates a feature vector 222 for the microblog post 214 using the one or more feature values 218 extracted by the feature value extractor 216. The predictor 204 then inputs the feature vector 222 into a decoder 224. The decoder 224 uses the feature vector 222 and the prediction model 226, which was previously trained in the offline mode, or training mode, described in FIG. 1, to generate a prediction 228.

In one illustrative embodiment, the prediction 228 may be in the form of a “yes” or “no” definitive answer to the likelihood of the microblog post 214 eliciting a response. In another illustrative embodiment, the prediction 228 may be in the form of a probability, of the microblog post 214 eliciting a response.

FIG. 2 is intended as an example, and not as an architectural limitation for different embodiments. For example, in other advantageous embodiments, the environment may be an online environment, having the prediction mechanism 202 predict the likelihood of a response for content other than social content, such as medical questions, legal inquiries, and/or any other type of content that is generated in order to elicit a response.

As used herein, the phrase “at least one of”, when used with a list of items, means that different combinations of one or more of the items may be used and only one of each item in the list may be needed. For example, “at least one of item A, item B, and item C” may include, for example, without limitation, item A or item A and item B. This example also may include item A, item B, and item C or item B and item C.

As used herein, when a first component is connected to a second component, the first component may be connected to the second component without any additional components. The first component also may be connected to the second component by one or more other components. For example, one electronic device may be connected to another electronic device without any additional electronic devices between the first electronic device and the second electronic device. In some cases, another electronic device may be present between the two electronic devices connected to each other.

The different advantageous embodiments recognize and take into account that current social networks provide a vast smorgasbord of information and digital communication. Billions of posts are disseminated but only a portion of those ever garner a response from the pertinent community.

Thus, various aspects of the subject matter described herein are directed towards response prediction. A prediction mechanism is configured to analyze a social element and generate a prediction associated with the social element using a prediction model.

Another aspect is directed towards predicting the likelihood of a response. A social element is received by a prediction mechanism. A feature set is generated for the social element. A prediction is generated using the feature set and a prediction model.

Yet another aspect is directed towards training a response predictor. A feature value extractor is configured to extract one or more feature values from one or more social elements. A feature vector generator is configured to generate one or more feature vectors for the one or more social elements using the one or more feature values extracted by the feature value extractor. A prediction model is configured to generate a prediction using the one or more feature vectors generated.

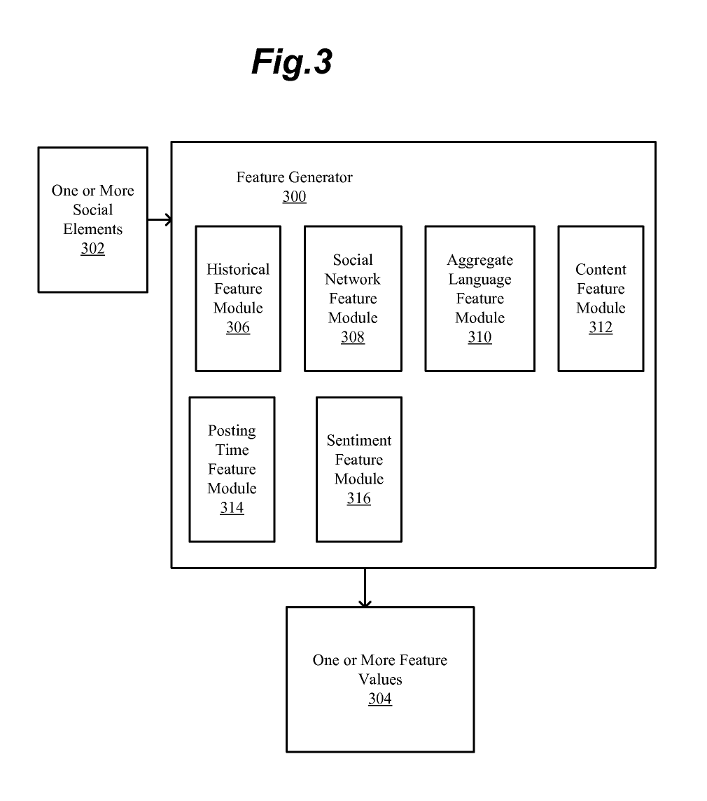

With reference now to FIG. 3, an illustration of a feature value extractor is depicted in accordance with an advantageous embodiment. The feature value extractor 300 may be an illustrative example of the feature value extractor 130 in FIG. 1 and/or the feature value extractor 216 in FIG. 2.

Feature value extractor 300 may include a number of feature modules for processing the one or more social elements 302 received from a social graph, such as social graph 106 in FIG. 1 and/or social graph 206 in FIG. 2, in order to generate the one or more feature values 304. In this illustrative embodiment, feature value extractor 300 may include, without limitation, a historical feature module 306, a social network feature module 308, an aggregate language feature module 310, a content feature module 312, a posting time feature module 314, and a sentiment feature module 316.

For illustrative purposes, the discussion of the feature modules will be described as processing Tweets®. However, the one or more social elements 302 may include any type of social element, such as a status update, a microblog post, a question, and/or any other suitable element, for example. In an offline mode the feature modules of the feature value extractor 300 may process a plurality of social elements at one time. In an online mode the feature modules of the feature value extractor 300 may process one social element at a time.

The historical feature module 306 processes a Tweet® to generate a feature value that corresponds to the history associated with the Tweet®. The history associated with a Tweet® may include, for example, without limitation, information about the user who posted the Tweet®, information about past Tweets® from that user, information about the history of the lexical items identified in the Tweet®, and/or any other suitable historical information. For example, the historical feature module 306 may process a Tweet® to generate an output such as a ratio of Retweeted Tweets® by the same user.

The social network feature module 308 processes a Tweet® to generate a feature value that corresponds to the social relationship associated with the author of the Tweet®. For example, the social network feature module 308 may process a Tweet® to generate an output such as a number of followers of the user of the Tweet®.

The aggregate language feature module 310 processes a Tweet® to generate a feature value that corresponds to the lexical items contained in the Tweet®. For example, the aggregate language feature module 310 may process a Tweet® to generate an output such as whether the Tweet® contain a specific hashtag or whether the Tweet® contain a mention of a particular word.

The content feature module 312 processes a Tweet® to generate a feature value that corresponds to the stop words contained in the Tweet®. Stop words may be, for example, without limitation, pronouns, articles, tokens, and/or any other suitable stop word. A stop word may be a language feature that is used to form a sentence, phrase, or thought, but does not convey content from the perspective of language analysis. For example, the content feature module 312 may process a Tweet® to generate an output such as the number of stop words in the Tweet® or the number of pronouns in the Tweet®.

The posting time feature module 314 processes a Tweet® to generate a feature value that corresponds to the timestamp associated with the Tweet®. For example, the posting time feature module 314 may process a Tweet® to generate an output such as a local time of day of the Tweet®, a day of the week of the Tweet ®, or whether or not the Tweet® was posted on a workday versus a weekend or holiday.

The sentiment feature module 316 processes a Tweet® to generate a feature value that corresponds to the sentiment contained in the Tweet®. Sentiment may refer to positive and negative words, feelings, emotions, and/or any other sentiment. For example, the sentiment feature module 316 may process a Tweet® to generate an output such as the number of positive words in the Tweet® or the number of negative words in the Tweet®.

The illustration of the feature value extractor 300 in FIG. 3 is not meant to imply physical or architectural limitations to the manner in which different advantageous embodiments may be implemented. Other components in addition and/or in place of the ones illustrated may be used. Some components may be unnecessary in some advantageous embodiments. Also, the blocks are presented to illustrate some functional components. One or more of these blocks may be combined and/or divided into different blocks when implemented in different advantageous embodiments.

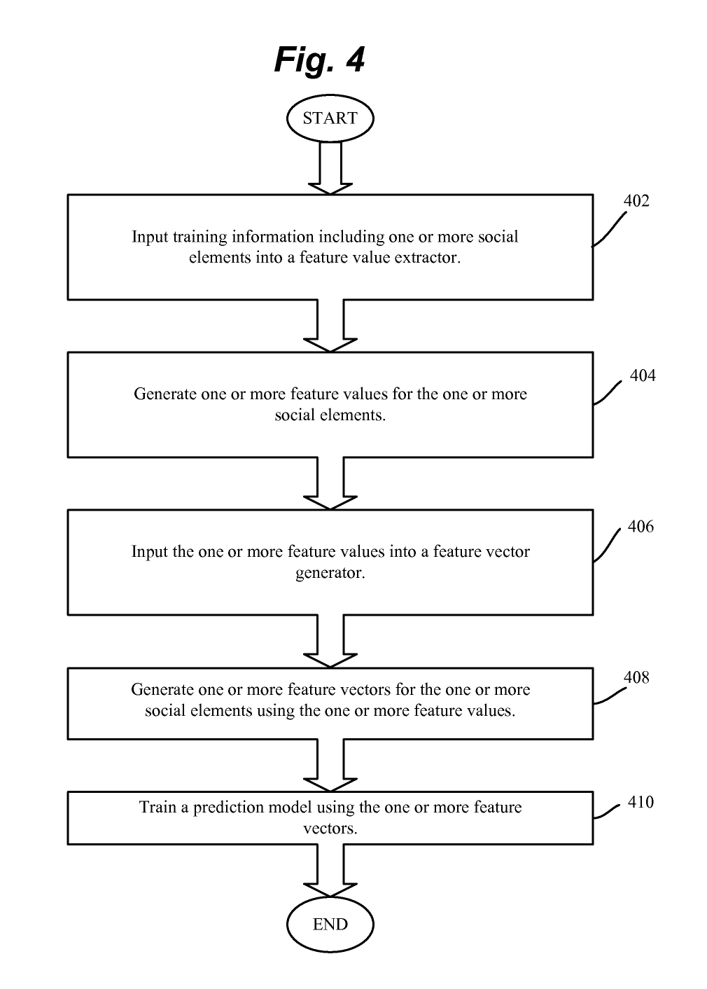

With reference to FIG. 4, an illustration of a flow diagram of training a response predictor is depicted in accordance with an advantageous embodiment. The flow diagram in FIG. 4 represents an example process that may be implemented by a prediction mechanism, such as the prediction mechanism 102 in FIG. 1, for example.

The process begins by inputting training information including one or more social elements into a feature value extractor (operation 402). The training information may be input by a trainer, such as trainer 104 in FIG. 1, for example. The training information may include, without limitation, one or more social elements, a sentiment lexicon, a stop word list, hashtag salience scores, word salience scores, and/or any other suitable information.

The process generates one or more feature values for the one or more social elements using the feature value extractor (operation 404). Each of the one or more feature values may correspond to the one or more social elements. The feature value extractor may use a number of algorithms in association with a number of feature modules to generate the one or more feature values.

The process inputs the one or more feature values into a feature vector generator (operation 406). The process then generates one or more feature vectors for the one or more social elements using the one or more feature values (operation 408). The feature vector generator uses the one or more feature values for each of the one or more social elements to generate a feature vector for each of the one or more social elements.

The process trains a prediction model using the one or more feature vectors (operation 410), with the process terminating thereafter. The prediction model may be, for example, a trained classifier configured to enable a predictor, such as predictor 204 in FIG. 2, to predict the likelihood of a response to a social element.

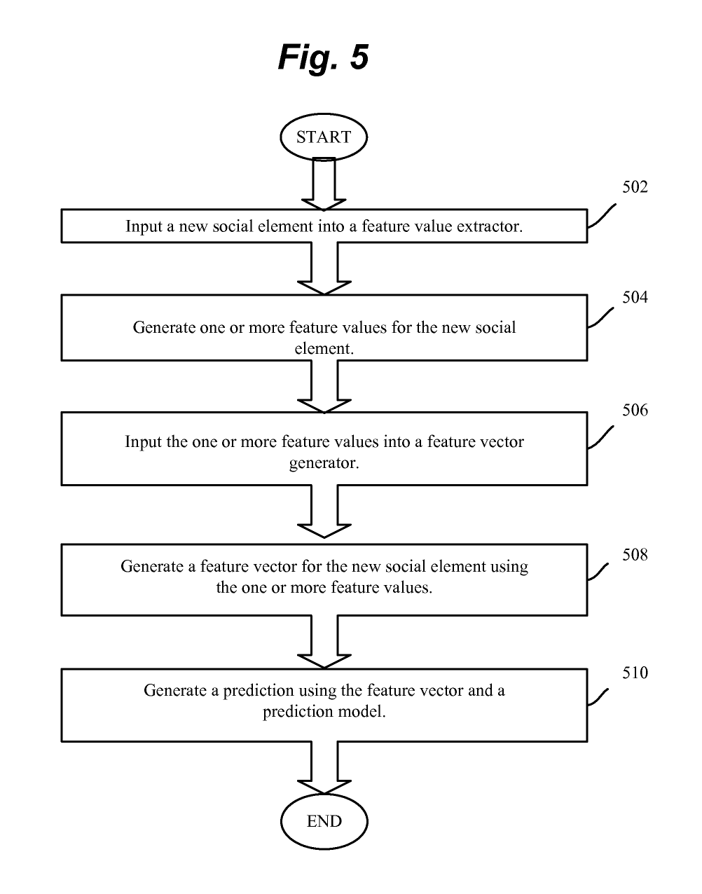

With reference now to FIG. 5, an illustration of a flow diagram of predicting the likelihood of a response is depicted in accordance with an advantageous embodiment. The flow diagram in FIG. 5 represents an example process that may be implemented by a prediction mechanism, such as the prediction mechanism 202 in FIG. 2, operating in a prediction mode, for example.

The process begins by inputting a new social element into a feature value extractor (operation 502). The new social element may be, for example, without limitation, a Tweet®, a microblog post, a status update, and/or any other suitable digital communication. The new social element may be input by the predictor 204 of the prediction mechanism 202 in FIG. 2, for example. The feature value extractor may be an illustrative implementation or instance of the feature value extractor 216 in FIG. 2, for example.

The process generates one or more feature values for the new social element using the feature value extractor (operation 504). The process inputs the one or more feature values into a feature vector generator (operation 506). The feature vector generator may be an illustrative implementation or instance of the feature vector generator 220 in FIG. 2, for example.

The process generates a feature vector for the new social element using the one or more feature values (operation 508). The process then generates a prediction using the feature vector and a prediction model (operation 510), with the process terminating thereafter. In one illustrative example, the feature vector generated for the social element received and the prediction model may both be input into a decoder, such as the decoder 224 in FIG. 2 for example, in order to generate the prediction.

In another illustrative example, the prediction model may directly output the prediction. The prediction may be in the form of a definitive in some illustrative examples, such as a “yes” or “no” as to the likelihood of generating a response based on the social element received. In another illustrative embodiment, the prediction may be in the form of a probability, such as a percentage of likelihood that a response will be generated based on the social element received.

In yet another illustrative example, the process may input a plurality of new social elements for prediction as to whether or not each of the plurality of new social elements will receive a response. The prediction mode may be implemented in an offline environment in the illustrative example of processing a plurality of new social elements.

The flowcharts and block diagrams in the different depicted embodiments illustrate example architecture, functionality, and operation of some possible implementations of apparatus, methods and computer program products. In this regard, each block in the flow diagram or block diagrams may represent a module, segment, or portion of computer usable or readable program code, which comprises one or more executable instructions for implementing the specified function or functions. In some alternative implementations, the function or functions noted in the block may occur out of the order noted in the figures. For example, in some cases, two blocks shown in succession may be executed substantially concurrently, or the blocks may sometimes be executed in the reverse order, depending upon the functionality involved.

The different advantageous embodiments can take the form of an entirely hardware embodiment, an entirely software embodiment, or an embodiment containing both hardware and software elements. Some embodiments are implemented in software, which includes but is not limited to forms, such as, for example, firmware, resident software, and microcode.

Furthermore, the different embodiments can take the form of a computer program product accessible from a computer usable or computer readable medium providing program code for use by or in connection with a computer or any device or system that executes instructions. For the purposes of this disclosure, a computer usable or computer readable medium can generally be any tangible apparatus that can contain, store, communicate, propagate, or transport the program for use by or in connection with the instruction execution system, apparatus, or device.

The computer usable or computer readable medium can be, for example, without limitation an electronic, magnetic, optical, electromagnetic, infrared, or semiconductor system, or a propagation medium. Non limiting examples of a computer readable medium include a semiconductor or solid state memory, magnetic tape, a removable computer diskette, a random access memory (RAM), a read-only memory (ROM), a rigid magnetic disk, and an optical disk. Optical disks may include compact disk—read only memory (CD-ROM), compact disk—read/write (CD-RAN) and DVD.

Further, a computer usable or computer readable medium may contain or store a computer readable or usable program code such that when the computer readable or usable program code is executed on a computer, the execution of this computer readable or usable program code causes the computer to transmit another computer readable or usable program code over a communications link. This communications link may use a medium that is, for example without limitation, physical or wireless.

A data processing system suitable for storing and/or executing computer readable or computer usable program code will include one or more processors coupled directly or indirectly to memory elements through a communications fabric, such as a system bus. The memory elements may include local memory employed during actual execution of the program code, bulk storage, and cache memories which provide temporary storage of at least some computer readable or computer usable program code to reduce the number of times code may be retrieved from bulk storage during execution of the code.

Input/output or I/O devices can be coupled to the system either directly or through intervening I/O controllers. These devices may include, for example, without limitation to keyboards, touch screen displays, and pointing devices. Different communications adapters may also be coupled to the system to enable the data processing system to become coupled to other data processing systems or remote printers or storage devices through intervening private or public networks. Non-limiting examples are modems and network adapters are just a few of the currently available types of communications adapters.

The different advantageous embodiments recognize and take into account that current social networks provide a vast smorgasbord of information and digital communication. Billions of posts are disseminated but only a portion of those ever garner a response from the pertinent community.

Thus, the different advantageous embodiments provide an apparatus and methods for predicting the likelihood of a response for a social element, such as a post or other digital communication disseminated into the online community.

The description of the different advantageous embodiments has been presented for purposes of illustration and description, and is not intended to be exhaustive or limited to the embodiments in the form disclosed. Many modifications and variations will be apparent to those of ordinary skill in the art. Further, different advantageous embodiments may provide different advantages as compared to other advantageous embodiments. The embodiment or embodiments selected are chosen and described in order to best explain the principles of the embodiments, the practical application, and to enable others of ordinary skill in the art to understand the disclosure for various embodiments with various modifications as are suited to the particular use contemplated.

### Example Operating Environment

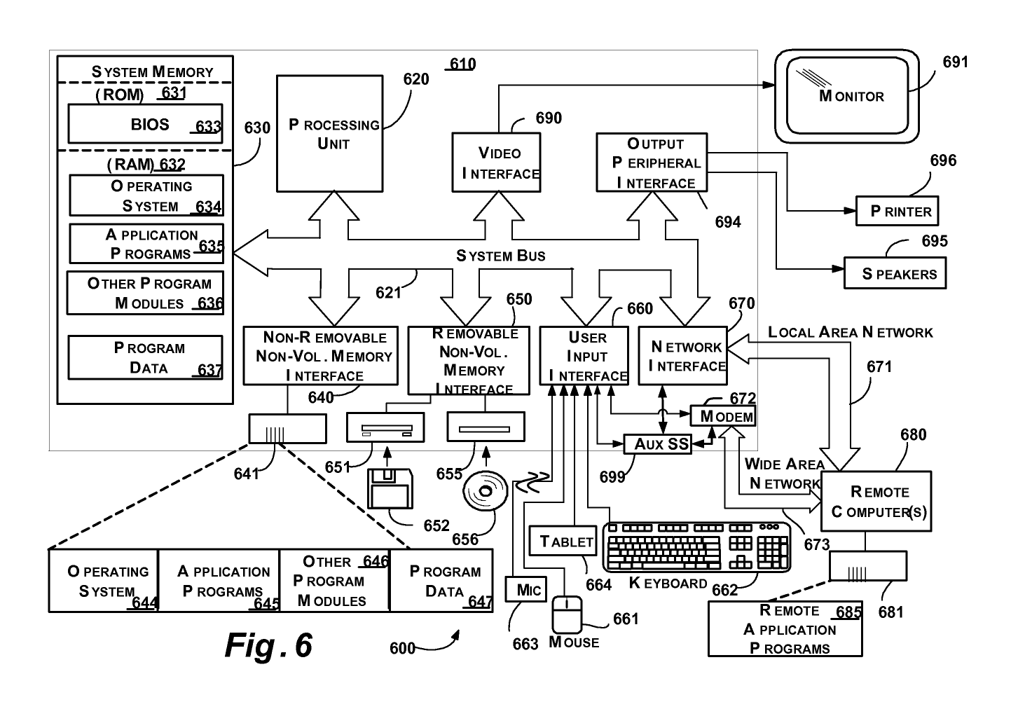

With reference now to FIG. 6, an illustrative example of a suitable computing and networking environment 600 is provided, into which the examples and implementations of any of FIGS. 1-6 as well as any alternatives may be implemented. The computing system environment 600 is only one example of a suitable computing environment and is not intended to suggest any limitation as to the scope of use or functionality of the invention. Neither should the computing environment 600 be interpreted as having any dependency or requirement relating to any one or combination of components illustrated in the example operating environment 600.

The invention is operational with numerous other general purpose or special purpose computing system environments or configurations. Examples of well-known computing systems, environments, and/or configurations that may be suitable for use with the invention include, but are not limited to: personal computers, server computers, hand-held or laptop devices, tablet devices, multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer- executable instructions, such as program modules, being executed by a computer. Generally, program modules include routines, programs, objects, components, data structures, and so forth, which perform particular tasks or implement particular abstract data types. The invention may also be practiced in distributed computing environments where tasks are performed by remote processing devices that are linked through a communications network. In a distributed computing environment, program modules may be located in local and/or remote computer storage media including memory storage devices.

With reference to FIG. 6, an example system for implementing various aspects of the invention may include a general purpose computing device in the form of a computer 610. Components of the computer 610 may include, but are not limited to, a processing unit 620, a system memory 630, and a system bus 621 that couples various system components including the system memory to the processing unit 620. The system bus 621 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The computer 610 typically includes a variety of computer-readable media. Computer-readable media can be any available media that can be accessed by the computer 610 and includes both volatile and nonvolatile media, and removable and non-removable media. By way of example, and not limitation, computer-readable media may comprise computer storage media and communication media. Computer storage media includes volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by the computer 610. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above may also be included within the scope of computer-readable media.

The system memory 630 includes computer storage media in the form of volatile and/or nonvolatile memory such as read only memory (ROM) 631 and random access memory (RAM) 632. A basic input/output system 633 (BIOS), containing the basic routines that help to transfer information between elements within computer 610, such as during start-up, is typically stored in ROM 631. RAM 632 typically contains data and/or program modules that are immediately accessible to and/or presently being operated on by processing unit 620. By way of example, and not limitation, FIG. 6 illustrates operating system 634, application programs 635, other program modules 636 and program data 637.

The computer 610 may also include other removable/non-removable, volatile/nonvolatile computer storage media. By way of example only, FIG. 6 illustrates a hard disk drive 641 that reads from or writes to non-removable, nonvolatile magnetic media, a magnetic disk drive 651 that reads from or writes to a removable, nonvolatile magnetic disk 652, and an optical disk drive 655 that reads from or writes to a removable, nonvolatile optical disk 656 such as a CD ROM or other optical media. Other removable/non-removable, volatile/nonvolatile computer storage media that can be used in the example operating environment include, but are not limited to, magnetic tape cassettes, flash memory cards, digital versatile disks, digital video tape, solid state RAM, solid state ROM, and the like. The hard disk drive 641 is typically connected to the system bus 621 through a non-removable memory interface such as interface 640, and magnetic disk drive 651 and optical disk drive 655 are typically connected to the system bus 621 by a removable memory interface, such as interface 650.

The drives and their associated computer storage media, described above and illustrated in FIG. 6, provide storage of computer-readable instructions, data structures, program modules and other data for the computer 610. In FIG. 6, for example, hard disk drive 641 is illustrated as storing operating system 644, application programs 645, other program modules 646 and program data 647. Note that these components can either be the same as or different from operating system 634, application programs 635, other program modules 636, and program data 637. Operating system 644, application programs 645, other program modules 646, and program data 647 are given different numbers herein to illustrate that, at a minimum, they are different copies. A user may enter commands and information into the computer 610 through input devices such as a tablet, or electronic digitizer, 664, a microphone 663, a keyboard 662 and pointing device 661, commonly referred to as mouse, trackball or touch pad. Other input devices not shown in FIG. 6 may include a joystick, game pad, satellite dish, scanner, or the like. These and other input devices are often connected to the processing unit 620 through a user input interface 660 that is coupled to the system bus, but may be connected by other interface and bus structures, such as a parallel port, game port or a universal serial bus (USB). A monitor 691 or other type of display device is also connected to the system bus 621 via an interface, such as a video interface 690. The monitor 691 may also be integrated with a touch-screen panel or the like. Note that the monitor and/or touch screen panel can be physically coupled to a housing in which the computer 610 is incorporated, such as in a tablet-type personal computer. In addition, computers such as the computer 610 may also include other peripheral output devices such as speakers 695 and printer 696, which may be connected through an output peripheral interface 694 or the like.

The computer 610 may operate in a networked environment using logical connections to one or more remote computers, such as a remote computer 680. The remote computer 680 may be a personal computer, a server, a router, a network PC, a peer device or other common network node, and typically includes many or all of the elements described above relative to the computer 610, although only a memory storage device 681 has been illustrated in FIG. 6. The logical connections depicted in FIG. 6 include one or more local area networks (LAN) 671 and one or more wide area networks (WAN) 673, but may also include other networks. Such networking environments are commonplace in offices, enterprise-wide computer networks, intranets and the Internet.

When used in a LAN networking environment, the computer 610 is connected to the LAN 671 through a network interface or adapter 670. When used in a WAN networking environment, the computer 610 typically includes a modem 672 or other means for establishing communications over the WAN 673, such as the Internet. The modem 672, which may be internal or external, may be connected to the system bus 621 via the user input interface 660 or other appropriate mechanism. A wireless networking component 674 such as comprising an interface and antenna may be coupled through a suitable device such as an access point or peer computer to a WAN or LAN. In a networked environment, program modules depicted relative to the computer 610, or portions thereof, may be stored in the remote memory storage device. By way of example, and not limitation, FIG. 6 illustrates remote application programs 685 as residing on memory device 681. It may be appreciated that the network connections shown are examples and other means of establishing a communications link between the computers may be used.

An auxiliary subsystem 699 (e.g., for auxiliary display of content) may be connected via the user interface 660 to allow data such as program content, system status and event notifications to be provided to the user, even if the main portions of the computer system are in a low power state. The auxiliary subsystem 699 may be connected to the modem 672 and/or network interface 670 to allow communication between these systems while the main processing unit 620 is in a low power state.

### Conclusion

While the invention is susceptible to various modifications and alternative constructions, certain illustrated embodiments thereof are shown in the drawings and have been described above in detail. It should be understood, however, that there is no intention to limit the invention to the specific forms disclosed, but on the contrary, the intention is to cover all modifications, alternative constructions, and equivalents falling within the spirit and scope of the invention.

What is claimed is:

1. A method comprising:
receiving, by a prediction mechanism, a social element;
generating a feature set for the social element; and
generating a prediction using the feature set and a prediction model.

2. The method of claim 1 wherein generating the feature set comprises generating a feature vector using one or more feature values extracted from the social element.

3. The method of claim 1 wherein generating the feature set comprises generating one or more feature values using a feature value extractor, and wherein the feature value extractor includes a number of feature modules for processing the social element to generate the one or more feature values.

4. The method of claim 1 wherein receiving the social element comprises receiving a microblog post.

5. The method of claim 1 wherein the steps are performed in an online environment.

6. The method of claim 1 wherein generating the prediction comprises outputting at least one of a definitive answer or a probability.

7. The method of claim 1, further comprising:
receiving, by the prediction mechanism, a plurality of social elements;
generating a plurality of features sets for the plurality of social elements, wherein a feature set is generated for each social element in the plurality of social elements; and
generating a prediction for the each social element in the plurality of social elements using the plurality of feature sets and a prediction model, wherein generating the prediction is performed in an offline environment.

8. An apparatus for response prediction, the apparatus comprising:
a prediction mechanism configured to analyze a social element and generate a prediction associated with the social element using a prediction model.

9. The apparatus of claim 8 wherein the prediction mechanism further comprises a trainer configured to receive a plurality of social elements from a social graph and train the prediction model using the plurality of social elements and training information.

10. The apparatus of claim 9 wherein the training information comprises at least one of a sentiment lexicon, a stop word list, hashtag salience scores, or word salience scores.

11. The apparatus of claim 8 wherein the prediction mechanism further comprises:
a feature value extractor configured to extract one or more feature values from the social element.

12. The apparatus of claim 11 wherein the prediction mechanism further comprises:
a feature vector generator configured to process the one or more feature values to generate a feature vector for the social element; and
a decoder configured to process the feature vector and generate the prediction using the prediction model.

13. A system comprising:
a feature value extractor configured to extract one or more feature values from one or more social elements;
a feature vector generator configured to generate one or more feature vectors for the one or more social elements using the one or more feature values extracted by the feature value extractor; and
a prediction model configured to generate a prediction using the one or more feature vectors generated.

14. The system of claim 13 wherein the prediction model is trained using training information, and wherein the training information includes at least one of a subset of social elements from a plurality of social elements provided by a social graph, a sentiment lexicon, a stop word list, hashtag salience scores, or word salience scores.

15. The system of claim 13 wherein each feature vector in the one or more feature vectors is associated with a corresponding social element in the one or more social elements.

16. The method of claim 13 wherein the feature value extractor includes a number of feature modules configured to process the one or more social elements and generate the one or more feature values.

17. The system of claim 13, further comprising:
a decoder configured to generate a prediction using the prediction model and the one or more feature vectors.

18. The system of claim 13 wherein the one or more social elements comprises one or more microblog posts.

19. The system of claim 13, wherein the one or more social elements is provided by a social graph.

20. The system of claim 19 wherein the social graph is based on a social networking service.
